(19) United States
(12) Patent Application Publication
(10) Pub. No.: US 2014/0192194 A1
(43) Pub. Date: Jul. 10, 2014

(54) Vehicle Surveillance System

(71) Applicants: Linda Bedell, Tallahassee, FL (US); Thedrick A. Walker, Tallahassee, FL (US)

(72) Inventors: Linda Bedell, Tallahassee, FL (US); Thedrick A. Walker, Tallahassee, FL (US)

(21) Appl. No.: 13/735,069

(22) Filed: Jan. 7, 2013

(51) Int. Cl. H04N 7/18

(52) U.S. Cl. CPC H04N 7/18
USPC 348/148

(57) ABSTRACT

A security system for monitoring activities occurring within and around a vehicle. The security system includes a video camera positioned to monitor activities occurring within said vehicle. A receiver receives video data and other data and stores the data. The receiver also monitors for defined triggering events. When a triggering event is detected, data associated with the time of the triggering event is stored for subsequent retrieval. The system also includes a method for transmitting the event data to an external device. A notice of the occurrence of the event is also sent to a defined notice receiving device.

### CROSS-REFERENCES TO RELATED APPLICATIONS

This application is a continuation-in-part of U.S. application Ser. No. 12/228,694, which is itself a continuation-in-part of U.S. application Ser. No. 11/591,860. The inventors listed for all three applications are the same.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of vehicular security systems. More specifically, this invention comprises a vehicle surveillance system having data recording and data transferring capabilities.

2. Description of the Related Art

Vehicular security systems seek to protect the owner of a vehicle from theft or occupants of a vehicle from hijacking. Various security systems and devices are currently used for such purposes, including car alarm systems, “panic” type transmitters, automobile demobilization systems, and GPS tracking systems. Although these systems and devices serve useful purposes, there remains a need for a system that would allow law enforcement to easily determine the identity of a thief or hijacker so that the thief or hijacker may be apprehended.

There is also a need for a system for monitoring “at-risk” individuals when they are driving or riding in a vehicle. For example, many parents desire the ability to monitor their children's driving when the parents are not present in the vehicle. Also, governmental agencies have a need to monitor individuals convicted of certain offenses, particularly when these convicted individuals are driving. In addition, school systems desire the ability to better monitor the conduct of their bus-riding students to prevent bullying and other disruptive behaviors that endanger the safety of the students.

It is therefore desirable to provide a security system for a vehicle which is capable of the previously described monitoring functions. It is also desirable for the security system to be capable of transferring video and/or audio data of activities occurring in the vehicle.

### BRIEF SUMMARY OF THE INVENTION

The present invention is a security system for monitoring activities occurring within a vehicle. The security system includes a video camera, microphone, and vehicle data acquisition system that are configured to record activities occurring within said vehicle. In one embodiment the video camera is attached to the rearview mirror and the microphone is attached to the top liner in the cabin.

A receiver is also provided. The receiver receives video, sound, and other data and stores the data. The receiver may be placed in the trunk or another secure location. A data port is provided on the receiver and is electronically connected to the storage device. The data port may be a USB (“Universal Serial Bus”) type data port. An external memory unit, such as a jump drive, is also provided for transferring memory from the hard drive to another location. The receiver includes an external memory unit detecting means configured to detect whenever the external memory unit is connected to the data port. The external memory unit detecting means and the recording means may both be provided as software or firmware in the receiver.

The receiver also monitors for defined triggering events, such as a door opening, a speed limit violation, or an impact. When a triggering event is detected, data associated with the time of the triggering event is stored for subsequent retrieval. The system also includes a method for wirelessly transmitting the event data to an external server.

A user is a person desiring to monitor activities within the vehicle—such as a parent. A user establishes an account on the server, with the account including user identification information and password protection. Data stored on the server is associated with a particular account. A user is able to log on to the server, provide the authentication, and then view data associated with the user's account. In the preferred embodiment, when a triggering event is detected a notice is sent to a defined notice receiving device, such as a smart phone in the user's possession. The notice alerts the user to the fact that a triggering event is occurred. The user is then preferably given the ability to immediately log onto the server and review the available data. The user may also be given the option of initiating a live feed from the vehicle, as well as two-way communication with the vehicle.

### BRIEF DESCRIPTION OF THE SEVERAL VIEWS OF THE DRAWINGS

FIG. 1 is a side view, illustrating the present invention installed in a vehicle.

FIG. 2 is a schematic, illustrating the present invention.

FIG. 3 is a side view, illustrating a receiver.

FIG. 4 is a schematic, illustrating the present invention.

FIG. 5 is a graphical view, depicting what one possible graphical user interface for the invention might look like.

FIG. 6 is a graphical view, depicting the representative graphical user interface at a later time.

FIG. 7 is a graphical view, depicting the representative graphical user interface at a still later time.

FIG. 8 is a graphical view, depicting the representative graphical user interface at a still later time.

FIG. 9 is a schematic, illustrating a communication network used in one of the preferred embodiments.

REFERENCE NUMERALS IN THE DRAWINGS

| | | | |
|---|---|---|---|
| 10 | car | 12 | video camera |
| 14 | microphone | 16 | receiver |
| 18 | computer | 20 | encoder/compressor |
| 22 | data port | 24 | transmitter |
| 26 | audio inputs | 28 | video input |
| 30 | encode step | 32 | compress step |
| 34 | write step | 36 | transmit step |
| 38 | determination step | 40 | delete step |
| 42 | record step | 44 | download step |
| 46 | detect key step | 48 | detect USB step |
| 50 | delete step | 52 | hard drive |
| 54 | recording indicator LED | 56 | memory indicator LED |
| 58 | data transfer indicator LED | 59 | graphical user interface |
| 60 | event log | 62 | time column |
| 64 | event type column | 66 | trigger column |
| 68 | data selections | 70 | play/pause button |
| 72 | captured image | 74 | communication provider |
| 76 | data link | 78 | data link |
| 80 | server | 82 | Internet |
| 84 | data link | 86 | data link |
| 88 | remote computer | 90 | smart phone |
| 92 | data link | | |

### DETAILED DESCRIPTION OF THE INVENTION

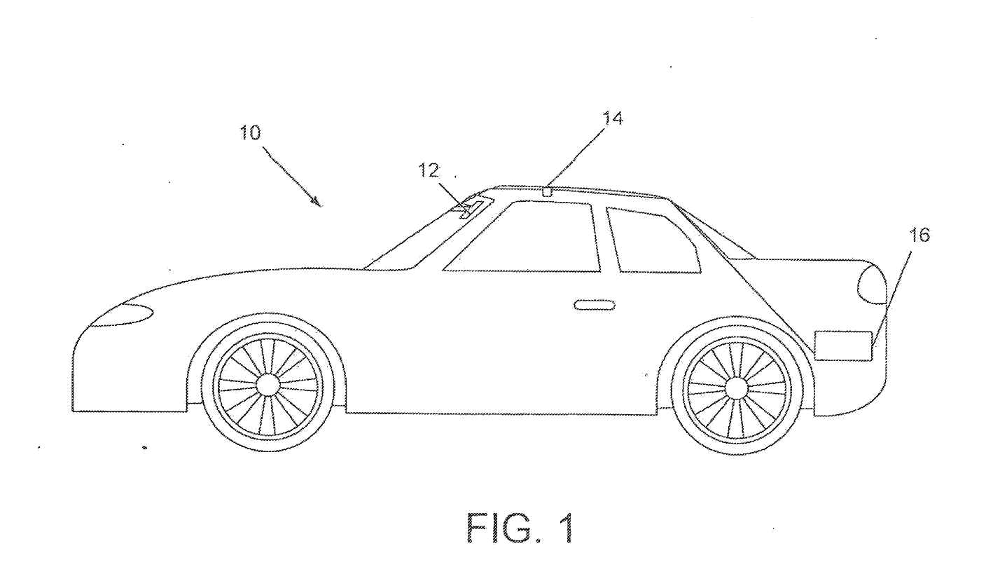

Many of the components of the present invention are illustrated generally in FIG. 1. Car 10 is equipped with video camera 12 and microphone 14. Video camera 12 is positioned in an orientation to monitor the activities occurring within the cabin of car 10. In the current example, video camera 12 is integrated with the rearview mirror of car 10 such that the lens of video camera 12 faces the occupants of the vehicle. Video camera 12 could also be positioned in a different location in car 10 or multiple video cameras may be used, with each camera having a different viewing angle of car 10. Microphone 14 is attached to the liner material on the top of the cabin so that it may pick up sounds from the front seats and back seats of the car. Microphone 14, like video camera 12, may be placed in other locations as well.

Microphone 14 and video camera 12 are electronically connected to receiver 16. Receiver 16 is placed in a secure location in car 10. In the present example, receiver 16 is placed in the trunk of the vehicle. Receiver 16 records and transmits video and sound data transmitted to receiver 16 from video camera 12 and microphone 14, respectively.

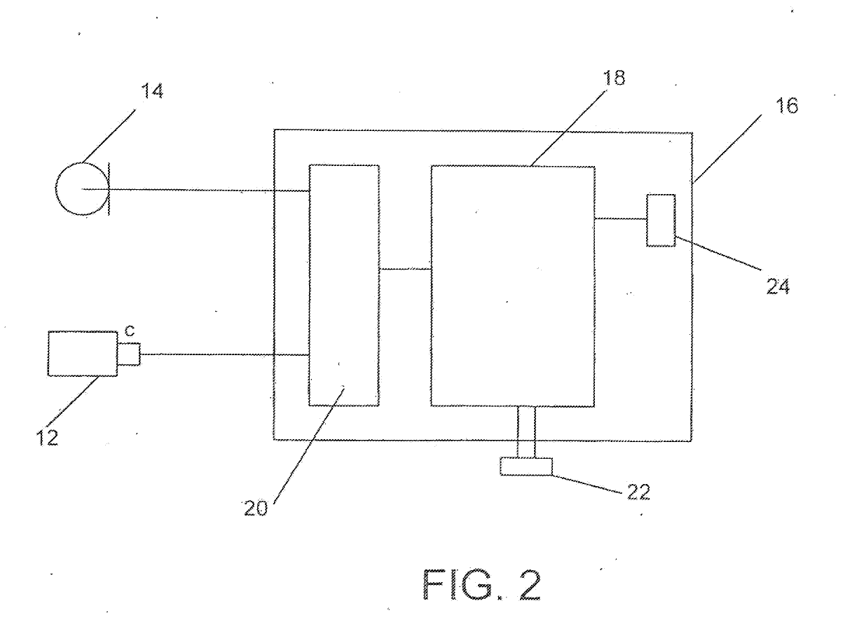

As illustrated in FIG. 2, microphone 14 transmits sound data to receiver 16 where it is compressed by encoder/compressor 20. Video camera 12 transmits video data to receiver 16 where it is encoded by encoder/compressor 20. Those skilled in the art will know that the encoder/compressor used for the microphone may be a different device than the one used for the video. The video information is considered important in the invention and the sound data should be viewed as an optional added feature. Thus, the sound data may well be compressed (and possibly even recorded) using a different device in some embodiments.

Encoded and compressed video and sound data is transmitted to computer 18. Computer 18 includes a hard drive or other suitable memory storage device for storing the video and sound data. Computer 18 also includes software or firmware which directs receiver 18 to perform its various functions and operations. In particular, computer 18 includes a recording means configured to record the video data to the hard drive and an external memory unit detecting means configured to detect whenever an external memory unit is connected to data port 22. Data port 22 is provided on the exterior of receiver 16 and is electronically connected to the hard drive. In the preferred embodiment, data port 22 is a USB (“Universal Serial Bus”) type data port. An external memory unit, such as a jump drive, is also provided for transferring memory from the hard drive to another location. The external memory unit detecting and recording operations may both be controlled and directed by software or firmware in contained in computer 18.

Receiver 16 preferably includes transmitter 24 which is configured to wirelessly transmit video and possibly sound data to a remote location. For example, transmitter 24 may transmit the data to a receiver on a personal computer. Transmitter 24 may transmit “live” video and/or sound feed utilizing various wireless transmission media that are known in the art. In one embodiment, receiver 16 may wirelessly transmit the data via satellite, GPRS (General Packet Radio Service), cellular or radio signals.

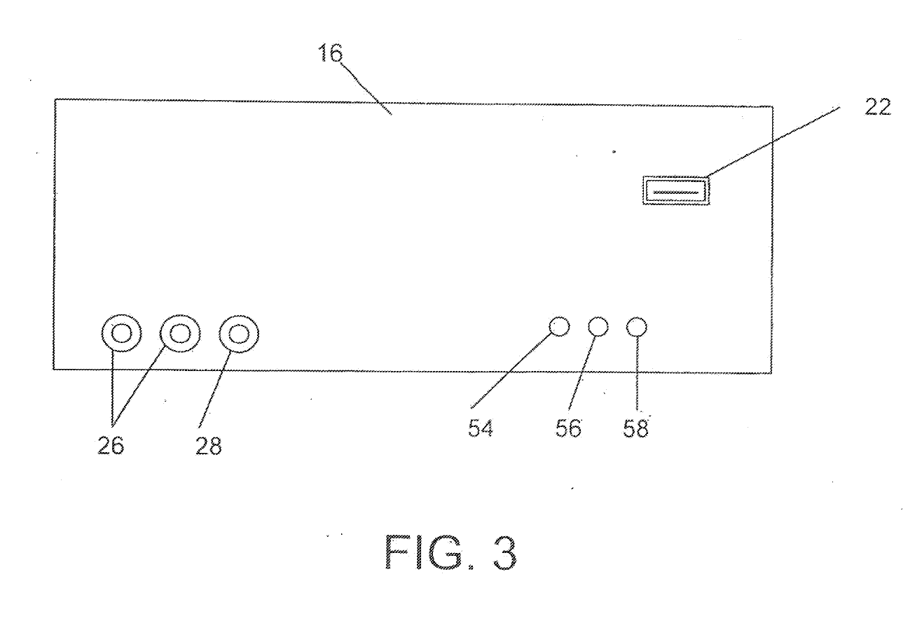

FIG. 3 shows a side view of receiver 16. Receiver 16 includes jacks for audio inputs 26 and video input 28. The type of input jacks used will obviously depend upon the type of video camera and microphone that is used. Receiver 16 also includes data port 22 which is configured to receive the external memory unit. Although it is not illustrated, receiver 16 also includes a power supply cord. Receiver 16 may draw power from car 10 or an auxiliary power source.

A series of LED lights are provided on the side of receiver 16 to provide status information to the user. Recording indicator LED 54 is on when receiver 16 is recording video and/or sound data to its hard drive. Memory indicator LED 56 is on when the amount of data stored in the hard drive is nearing the capacity of the hard drive. Memory indicator LED 56 may be set to turn on at any predefined memory usage threshold, however. Data transfer indicator LED 58 is on when data is being transferred from the hard drive to the external memory unit. Data transfer indicator LED 58 turns off when the transfer is complete.

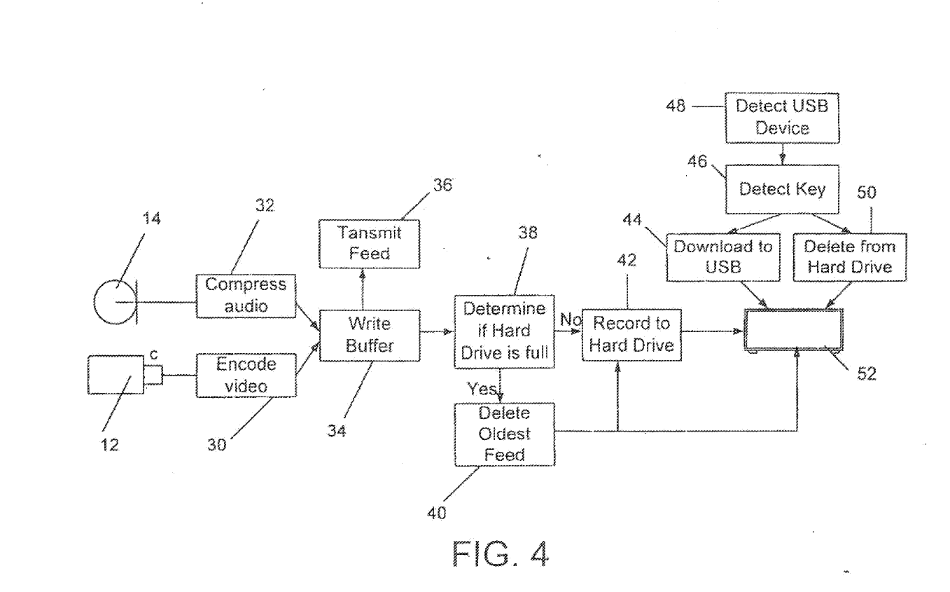

A schematic illustrating operation of the present invention is provided in FIG. 4. Audio data from microphone 14 is compressed, as indicated by compress step 32. Video data from video camera 12 is encoded concurrently with the compression of audio data, as indicated by encode step 30. A buffer is then written which combines the encoded video and compressed audio, as indicated by write step 34. This “feed” may be transmitted “live” wirelessly as indicated by transmit step 36. Simultaneous to the live transmission, the computer in the receiver determines whether hard drive 52 is full or contains a predefined threshold of video and/or audio data as indicated by determination step 38. Determination step 38 is iteratively performed at predefined time intervals during the recording process. If it is determined that the hard drive is full or contains the predefined threshold quantity of data, a portion of the oldest data is deleted, as indicated by delete step 40. The portion of data that is deleted may correspond to a predefined interval of time. For example, the oldest 30 minutes or hour of data may be deleted when such a determination is made. It should be noted that smaller or larger intervals of time may also be used. If it is determined that the hard drive is not full or does not contain the predefined quantity of data, the data is recorded to hard drive 52 as indicated by record step 42.

The computer in receiver 16 also has a means for detecting whenever the external memory unit is plugged into data port 22, as indicated by detect USB step 48. If an external memory unit is detected, the computer looks to see if the external memory unit has a security key as indicated by detect key step 46. The security key authenticates that the external memory unit is an authorized device for receiving data from receiver 16. Once the computer validates that an external memory unit is authorized, the computer downloads the data stored in hard drive 52 to the external memory unit as indicated by download step 44. The computer also deletes the data from hard drive 52 during or after transfer of the data to the external memory unit as indicated by delete step 50.

The operations illustrated in FIG. 4 may be directed and controlled by software or firmware in receiver 16. The reader will note that data compression need not involve a separate piece of hardware. The compression and encoding may be controlled by the same software of firmware that controls the other operations of the system. This allows for greater data security and makes the device very easy to use. Unlike conventional surveillance systems which record data to a tape or other removable storage medium, the present invention stores data to a hard drive. Once stored to the hard drive, the data cannot be deleted unless the user has an external memory unit with the appropriate security key. Microphone 14, video camera 12, and receiver 16 are preferably installed in such a manner that the security system cannot easily be detected. This further reduces the risk that a thief, hijacker, or kidnapper would discover the security system. Because the preferred system transmits a live feed wirelessly, a record of the data may also be kept on a remote system. This is particularly useful if the receiver is destroyed or cannot otherwise be recovered.

Of course, the previously mentioned transmission of live video and sound data can be relatively expensive. In addition, the bandwidth required for such transmissions may be unavailable at time. Thus, it is desirable to provide an embodiment which is not dependent upon the transmission of the live data. One approach is to write the data to the storage device in a “loop” fashion. In this approach, once the storage device is full, the oldest data is overwritten by the newest data. Thus, if the device is capable of storing two hours' worth of date, the most recent two hours of recording will be present on the storage disk.

The limitation of a simple “loop” approach is the obvious fact that data that is older than the loop cycle time is lost. Using the two-hour example, an event which occurred three hours in the past will be overwritten and lost. Of course, most data will be of no interest since nothing of significance will occur for most time intervals. One solution is to devise a system which records in a “loop” fashion, but which also detects and saves significant events.

Another approach which is somewhat analogous to the “loop” configuration is to continually write data into a temporary memory (which will generally have a much smaller capacity than the storage used for the longer lasting memory). The data written into the temporary memory is looped. However, if a “triggering event” is detected, then the data associated with the triggering event is transferred from the temporary memory to a permanent memory.

One way to save significant events is to define these triggering events to be things which are often associated with items of interests. As the invention is intended to be implemented in an automobile, these triggering events will preferably be automobile-specific. Exemplary triggering events include the following:

1. Opening of a door, including a trunk lid or hatchback;

2. Closing of a door, including a trunk lid or hatchback;

3. Detection of a car alarm signal;

4. Excessive acceleration (in any direction or in a specific direction, such as imposed by heavy braking or an impact);

5. Loud noises;

6. Excessive vehicle speed;

7. Excessive engine speed;

8. Wheel slip; and

9. Other user-defined conditions.

Those skilled in the art will know that most modern vehicles have an integrated data collection system which gathers data concerning engine functions, driver inputs (throttle, brake, and steering, conditions), ambient conditions, and vehicle conditions (such as acceleration and wheel slip). All this information may optionally be fed into the receiver and stored for future retrieval (though many embodiment would only include a much smaller list of parameters). All this information can also be used to define a triggering event. As one example, a user might define a particular triggering event as the combination of a high throttle input combined with significant wheel slip.

As mentioned previously, when a triggering event is detected, the system saves a data set including the triggering event and the data being collected for a defined time period before the triggering event, during the triggering event, and after the triggering event. The data for the period before the triggering event is available from the temporary memory. The software merely retrieves this data and adds it to the data set being created.

Once a defined period has passed after the triggering event, the normal loop configuration of storing data into the temporary memory resumes. In fact, in some embodiments it is possible to never interrupt the loop routine. The data set being saved in association with the triggering event is then saved in parallel with the data being written to the temporary memory. However, the data set associated with the triggering event (stored separately in the permanent memory) cannot be overwritten without a prior authorization from the user.

Thus, at any time the memory device will contain a log of triggering events and associated data sets and another loop of sequential data covering a much longer time period. The log of triggering events may contain data that is days, weeks, or even months old, whereas the balance of the data will be recent material stored by the loop routine.

The “user’ in this context is likely not the vehicle operator, but rather the individual having control and access to the surveillance system. A typical user might be the parent of a teenage driver. The teenage driver would be the vehicle operator. Data saved by the receiver could be downloaded to another computing device using any conventional means. Examples include a wireless transmission, a jump drive, a flash drive, or a cable connection. Access to the data should be password-protected (or restricted using other security measures) so that only the user can access the data and delete stored triggering event logs.

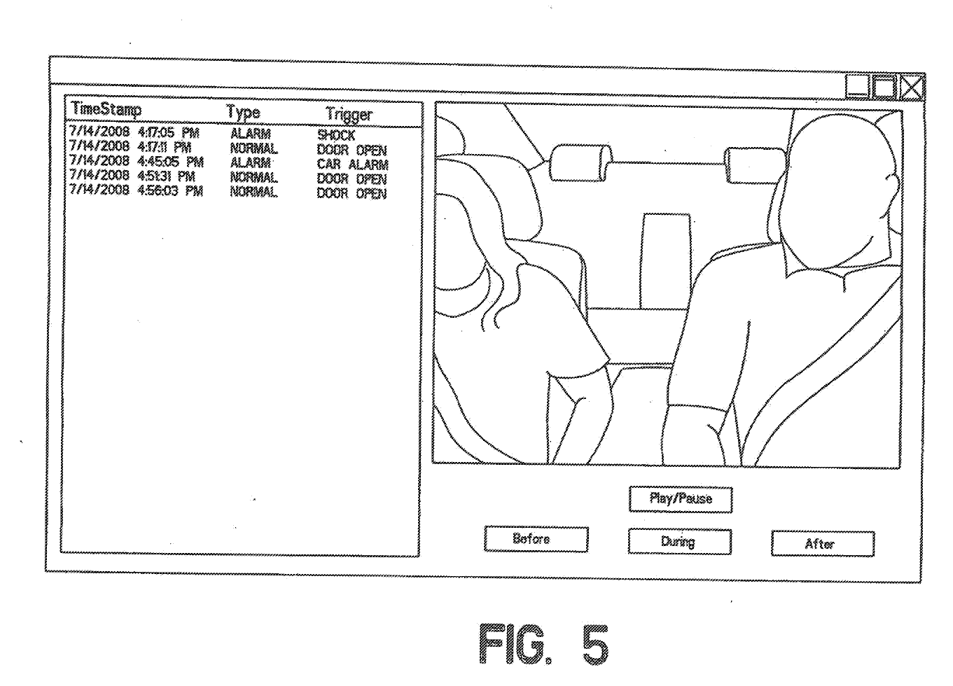

A graphical user interface (“GUI”) is preferably provided for the user. This can assume many forms. FIGS. 5-8 illustrate one simple example among the many possibilities. Once the user has downloaded data from the receiver, he or she may wish to review the data. FIG. 5 shows a portion of the GUI suited for this purpose.

FIG. 5 depicts graphical user interface 59. The left side of the display shows event log 60, which may display some or all of the data sets available. Time column 62 shows the time at which each triggering event occurred. Event type column 64 shows the type of event which was recorded (This is displayed if the user chooses to categorize events into classes such as “NORMAL,” “ALARM,” “ENGINE FUNCTION,” etc.). Trigger column 66 displays the actual triggering event.

For example, the event log shows that at 4:17:36 PM on Jul. 14, 2008, a triggering event (a door opening or closing) occurred. When the user selects this particular event, the right side of the user interface shows captured images associated with that event. Data selections 68 allow the user to choose to see the video and/or sound data occurring immediately before, during, and after the event. Play/pause button 70 allows the user to play or pause the video.

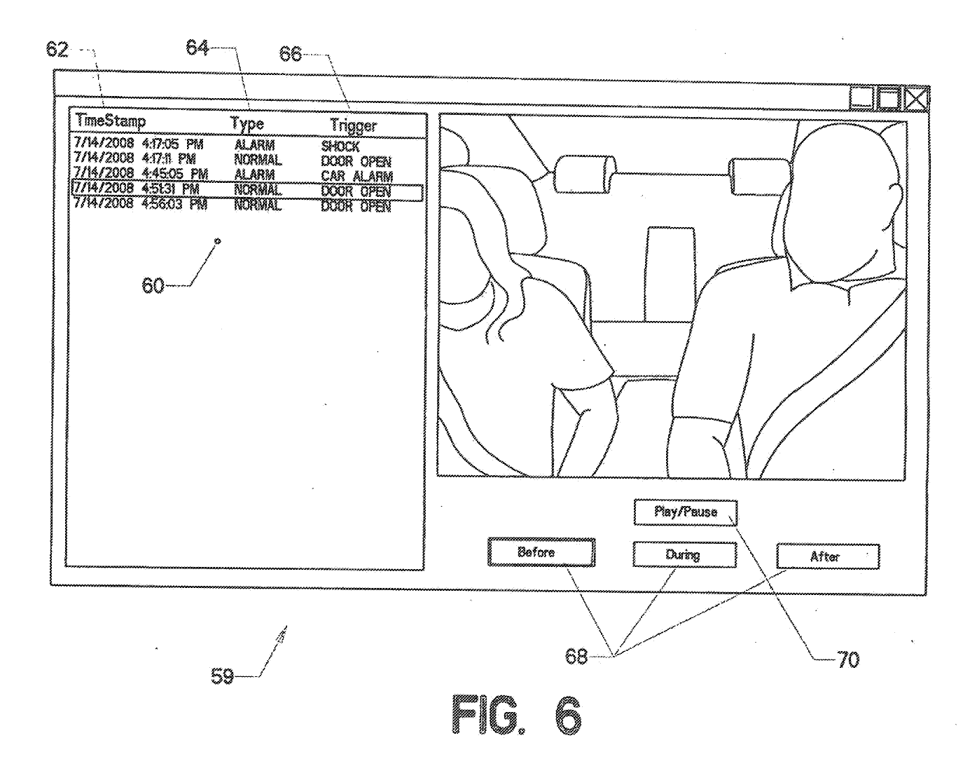

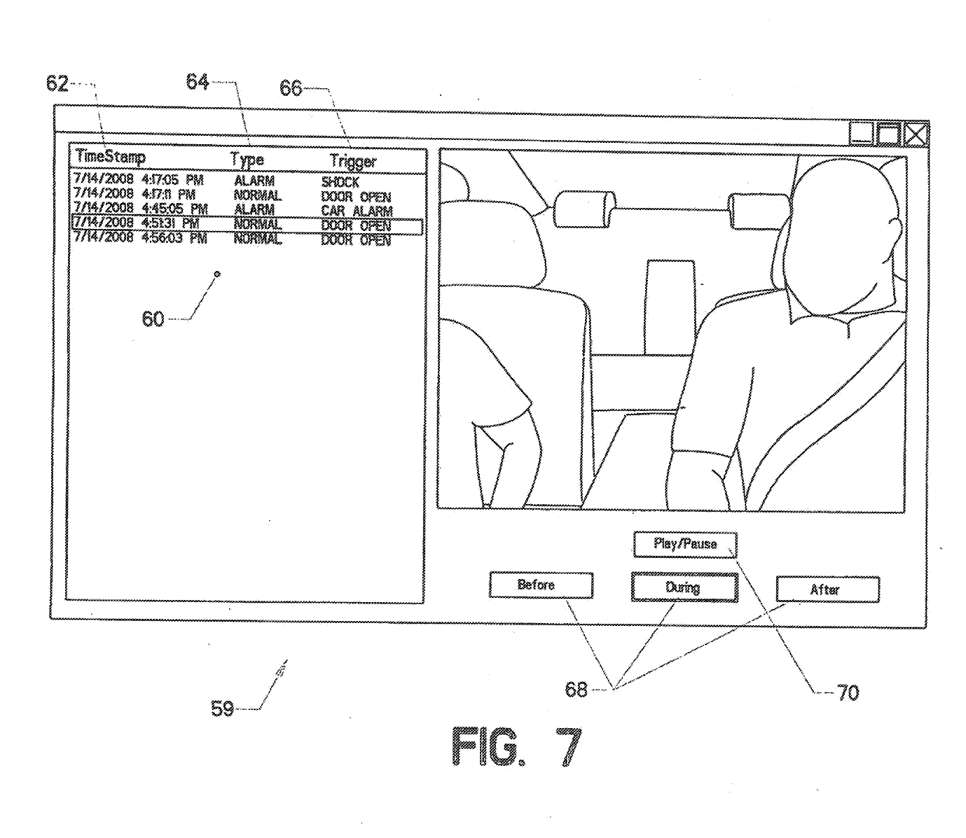

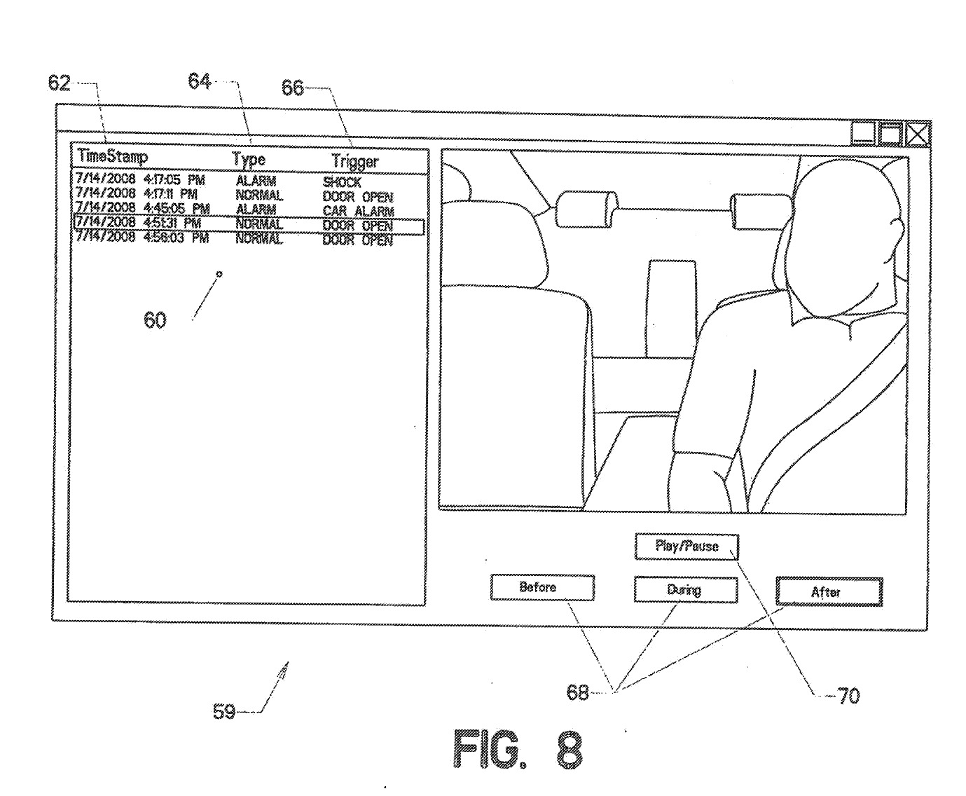

If the user selects the “Before” button, the video will show a passenger seated in the front passenger seat—as shown in FIG. 6. In FIG. 7, the user has selected the “During” button. This shows the video as the passenger exits the car. In FIG. 8, the user has selected the “After” button. This shows the empty passenger seat. Thus, by reviewing the video data associated with the selected triggering event, the user will know that the door was opened when a particular passenger exited the vehicle. The video allows the user to determine who the passenger was as well.

The user is preferably able to set how much data should be stored for each triggering event, and can even set different amounts of data for each type of event. For the door example, a relatively small amount of data would likely be sufficient (possibly 3 seconds of video before the trigger, and six seconds after the trigger). For other events, such as substantial accelerations that might be associated with an accident, the user might wish to save 30 seconds or more. The user is preferably given the ability to define different storage criteria for different triggering events.

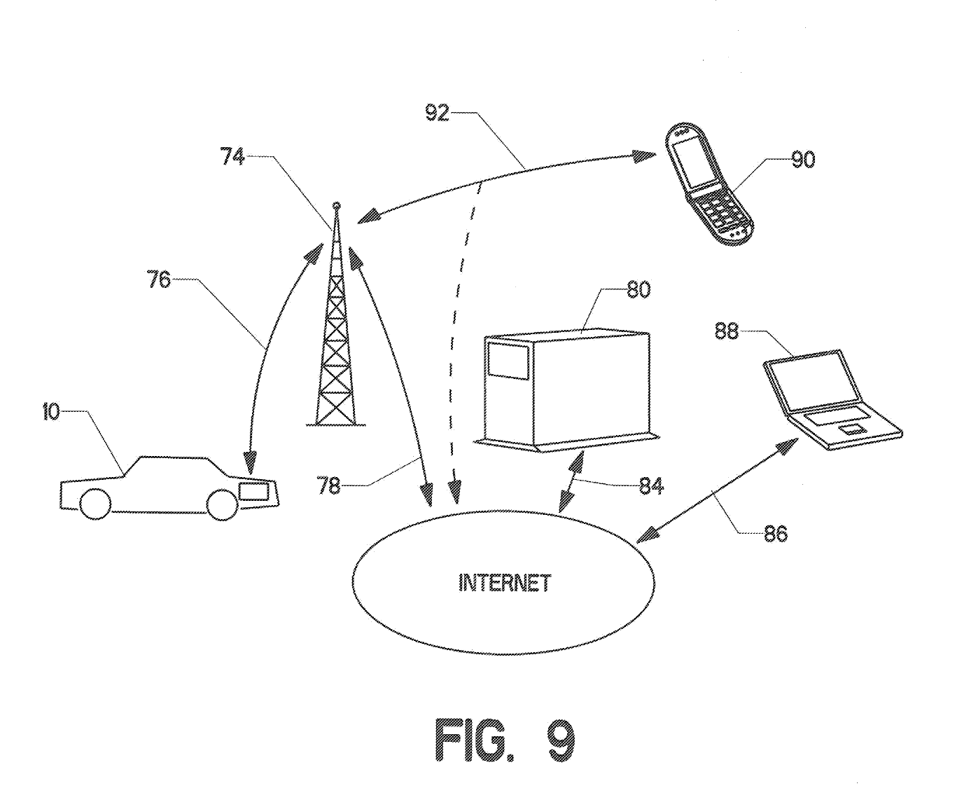

The preferred embodiment will now be discussed in greater detail in order to aid the reader's understanding. FIG. 9 graphically depicts the communication events that are preferably included in the preferred embodiment. Receiver 16 resides in car 10 as explained previously. A radio frequency data link 76 is provided between receiver 16 and communication provider 74. The communication provider is typically a cellular provider but the term would also include other types of communication networks, such as the IRIDIUM satellite communication network.

Data link 78 is provided between communication provider 74 and the Internet 82. Data link 84 is provided between the Internet 82 and server 80. Data link 86 is provided between the Internet 82 and remote computer 88. Data link 92 is provided between communication provider 74 and one or more smart phones 90. Alternatively, data link 92 may be provided via the Internet.

The network thus described can operate in many different ways. A typical operation, as explained previously, involves a parent wishing to monitor the driving activities of a child. The parent is the “user” and the child is the “vehicle operator.” The parent has access to remote computer 88 and possibly smart phone 90 as well.

Receiver 16 monitors for triggering events occurring during the operation of car 10, as described previously. When a triggering event is detected, the accompanying video and other associated data (such as audio, vehicle parameters, etc.) is saved to the non-volatile memory on-board receiver 16. The same data (or a selected subset thereof) is preferably compressed and sent as a radio frequency transmission via data link 76 to communication provider 74.

Communication may be established between the user and receiver 16 in a variety of ways. However, the preferred method uses the Internet. Communication provider 74 is connected to the Internet 82 via data link 78. Server 80 is connected to the Internet via data link 84. Remote computer 88 is connected to the Internet via data link 86. Finally, smart phone 90 may be connected to the Internet via communication provider 74 or some other communication provider (such as a WiFi link or a different cellular communication provider).

The data relating to a particular triggering event is transmitted ultimately to server 80 where it is stored. Server 80 may include banks of multiple memory storage devices and is preferably capable of storing a great deal of data. FIG. 9 depicts only a single car and a single user. However, in actuality, the present invention contemplates many users and many cars being monitored.

The data for each triggering event is preferably transmitted shortly after the event occurs (in some cases experiencing almost no delay). However, in some instances the data link 76 may be degraded or absent altogether. In that case the receiver retains the data for each triggering event and transmits the data for all previously untransmitted events as soon as communication is reestablished.

Each user establishes a user identity and a password-protected access account on server 80. A parent typically creates this account when he or she subscribes to the monitoring service. The account information includes a user identity and a password associated with that user identity. Once established, receiver 16 uploads the data concerning each triggering event and the data is associated with a particular user account. A user who has furnished proper authentication is only allowed to view data associated with the user's account.

Whenever the parent wishes to review the data, he or she uses remote computer 88 to log onto the account previously established on server 80. The parent must enter the correct password in order to gain access to the stored data. The parent is then provided with a suitable user interface such as depicted in FIGS. 5-8. The parent is able to review the triggering events and the associated data (such as video and acceleration) as he or she desires.

While this approach is effective, it is impractical to expect the parent to regularly log onto server 80 and retrieve and review the stored information in order to monitor the operation of the car. It is therefore desirable to include a “notice” provision in the communication scheme. The parent defines triggering events (including possibly all triggering events) that will trigger a notice event. A “notice event” means that the parent will be notified of the occurrence of the triggering event in a proactive way.

In the preferred embodiment, the notice is transmitted to the parent via email, SMS text message, or a prerecorded audio message that is transmitted to a cell phone number or a land line number. In the most preferred embodiment, the parent designates a portable computing device—such as smart phone 90—to receive the notice. An email or SMS text message is then sent to smart phone 90. (Note, however, that a conventional land-line telephone could be the designated notice-receiving device).

The parent receives the notice via his or her smart phone 90 and thereby immediately learns that a triggering event has occurred in car 10. It is desirable to send along additional information so that the parent immediately knows whether the event is one needing further review. For example, the notice may include:

(1) The type of event (“shock,” “door open,” “car alarm activated”);

(2) A single image ties to the event (such as a single frame of the video feed extracted after a “door closed” event in order to indicate whether a person just entered the vehicle);

(2) A brief sample of the audio data; and

(4) The current location of the vehicle, assuming that receiver 16 has access to GPS data and is able to determine the car's location.

For instance, a parent may have instructed the vehicle operator that a certain individual was not allowed to be in the car. The parent might then receive an SMS text message on her smart phone indicating (1) that a door had opened and closed, and (2) including a static image taken from the video. The parent might then open the static image and determine the identity of the individual entering the car. If the parent is unable to identify the person, then she might log onto server 80 in order to review the video itself. The parent could log on using remote computer 88. Of course, as those skilled in the art will know, the parent might simply log on using the smart phone itself. In other words, smart phone 90 and remote computer 88 may be the same device in some embodiments.

In addition to these features, the preferred embodiments may contain one or more of the following additional features:

(1) The ability of the user (parent) to activate a “live feed” of audio, video, car data (or a combination of some or all of these) from the receiver to the remote computer. This might be done if the parent receives a notice of something suspicious and wishes to more closely monitor an ongoing situation. The term “live feed” should be understood to encompass transmission and bandwidth limitations. For instance, bandwidth limitations might limit the feed rate to one video frame per second. Likewise, transmission delays of 1 second to 60 seconds may occur;

(2) The ability of the user (parent) to establish two-way communications with receiver 16 and the occupants of the vehicle, either upon receipt of a notice or at any time. If, for example, the parent is suspicious of a person entering the vehicle, the parent might transmit the audio message “Who just entered the vehicle?” which would be broadcast in the car. The microphone in the car would then pick up the response and the receiver would transmit the response back to the parent;

(3) The ability of the user (parent) to receive updated reports regarding the position of the car;

(4) The ability of the user (parent) to log onto the server from any computing device, so long as the parent provides the right information regarding the account identity and the password;

(5) The ability of the server to use cloud computing or other distributed file storage to perform the functions of its associated memory bank;

(6) The ability of the user (parent) to receive a single frame of video taken from the data set along with a notice sent to the defined notice receiving device;

(7) The ability of the user (parent) to receive a segment of video taken from the data set along with the notice sent to the defined notice receiving device; and

(8) The provision of a vehicle data acquisition system that monitors vehicle operational parameters and saves these as part of the data set. Exemplary operation parameters include vehicle speed, engine speed, throttle position, gear selected, brake position, acceleration, and the state of any available dynamic stability control (“DSC”) system.

The term “server” in this description should be broadly construed to mean any device that receives and stores data and subsequently provides access to that data. A particular “server” may in fact encompass a network of many individual computers running in different locations.

The preceding description contains significant detail regarding the novel aspects of the present invention. It should not be construed, however, as limiting the scope of the invention but rather as providing illustrations of the preferred embodiments of the invention. As an example, the external memory unit need not be USB compatible device. In fact, the term “hard drive” could encompass any type of permanent memory now in existence or hereafter developed. Likewise, data port 22 can be any type of transferring device suitable for transferring data from hard drive 52 to an external memory unit. Such a variation would not alter the function of the invention. Thus, the scope of the invention should be fixed by the following claims, rather than by the examples given.

Having described our invention, we claim:

1. A method allowing a user to monitor activities occurring within a vehicle comprising:
a. providing a video camera positioned to monitor activities occurring within said vehicle;
b. providing a receiver configured to receive video data transmitted from said video camera, said receiver including a memory storage for selectively recording said video data, said receiver being mounted in said vehicle;
c. recording said video data fed from said video camera in a continuous loop, wherein the newest video data fed from said video camera is written over the oldest video data fed from said video camera;
d. defining at least one triggering event;
e. providing said receiver with a method of detection for said at least one triggering event;
f. upon the detection of said at least one triggering event, creating a first data set including said at least one triggering event, a portion of said video data preceding said at least one triggering event for a defined time period, a portion of said video data that is contemporaneous with said triggering event, and a portion of said video data recorded after said at least one triggering event for a defined time period;
g. wirelessly transmitting said first data set to a communication provider;
h. providing a server having an associated memory bank;
i. providing an account for said user on said server, said account including a defined user identity, a defined password, and a defined notice receiving device, said account being configured to conditionally allow said user access to said account upon presentation by said user of said defined password;
j. transferring said data set from said communication provider to said memory bank associated with said server;
k. storing said data set in said memory bank, said data set being associated with said user account;
l. upon said server receiving said data set, transmitting a notice of said triggering event to said defined notice receiving device;
m. providing Internet access to said server, whereby said user can gain access to log onto said server, provide said user identity and said password, and thereby gain the ability to review said data set; and
n. providing a graphical user interface allowing said user to view said data set.

2. A method allowing a user to monitor activities occurring within a vehicle as recited in claim 1, wherein said notice assumes the form of an email describing said triggering event.

3. A method allowing a user to monitor activities occurring within a vehicle as recited in claim 1, wherein said notice assumes the form of a text message describing said triggering event.

4. A method allowing a user to monitor activities occurring within a vehicle as recited in claim 2, wherein at least a frame of video taken from said data set is transmitted along with said notice.

5. A method allowing a user to monitor activities occurring within a vehicle as recited in claim 3, wherein at least a frame of video taken from said data set is transmitted along with said notice.

6. A method allowing a user to monitor activities occurring within a vehicle as recited in claim 2, wherein upon receipt of said notice said user is given the ability to receive a live video feed from said receiver in said car.

7. A method allowing a user to monitor activities occurring within a vehicle as recited in claim 3, wherein upon receipt of said notice said user is given the ability to receive a live video feed from said receiver in said car.

8. A method allowing a user to monitor activities occurring within a vehicle as recited in claim 2, wherein upon receipt of said notice said user is given the ability to transmit voice data from said defined notice receiving device to said car.

9. A method allowing a user to monitor activities occurring within a vehicle as recited in claim 3, wherein upon receipt of said notice said user is given the ability to transmit voice data from said defined notice receiving device to said car.

10. A method allowing a user to monitor activities occurring within a vehicle as recited in claim 1, wherein said defined notice receiving device is a smart phone.

11. A method allowing a user to monitor activities occurring within a vehicle comprising:
a. providing a video camera positioned to monitor activities occurring within said vehicle;
b. providing a microphone positioned to monitor sound occurring within said vehicle;
c. providing a vehicle data acquisition system, configured to monitor operational parameters of said vehicle;
d. providing a receiver configured to receive video data transmitted from said video camera, audio data transmitted from said microphone, and vehicle operational parameters received from said vehicle data acquisition system, said receiver including a memory storage for selectively recording said data, said receiver being mounted in said vehicle;
e. recording said data fed from said video camera, said microphone, and said vehicle data acquisition system in a continuous loop, wherein the newest data is written over the oldest data;
f. defining at least one triggering event;
g. providing said receiver with a method of detection for said at least one triggering event;
h. upon the detection of said at least one triggering event, creating a first data set including said at least one triggering event, a portion of said data preceding said at least one triggering event for a defined time period, a portion of said data that is contemporaneous with said triggering event, and a portion of said data recorded after said at least one triggering event for a defined time period;
i. wirelessly transmitting said first data set to a communication provider;
j. providing a server having an associated memory bank;
k. providing an account for said user on said server, said account including a defined user identity, a defined password, and a defined notice receiving device, said account being configured to conditionally allow said user access to said account upon presentation by said user of said defined password;
l. transferring said data set from said communication provider to said memory bank associated with said server;
m. storing said data set in said memory bank, said data set being associated with said user account;
n. upon said server receiving said data set, transmitting a notice of said triggering event to said defined notice receiving device;
o. providing Internet access to said server, whereby said user can gain access to log onto said server, provide said user identity and said password, and thereby gain the ability to review said data set; and
p. providing a graphical user interface allowing said user to view said data set.

12. A method allowing a user to monitor activities occurring within a vehicle as recited in claim 11, wherein said notice assumes the form of an email describing said triggering event.

13. A method allowing a user to monitor activities occurring within a vehicle as recited in claim 11, wherein said notice assumes the form of a text message describing said triggering event.

14. A method allowing a user to monitor activities occurring within a vehicle as recited in claim 12, wherein at least a frame of video taken from said data set is transmitted along with said notice.

15. A method allowing a user to monitor activities occurring within a vehicle as recited in claim 13, wherein at least a frame of video taken from said data set is transmitted along with said notice.

16. A method allowing a user to monitor activities occurring within a vehicle as recited in claim 12, wherein upon receipt of said notice said user is given the ability to receive a live video feed from said receiver in said car.

17. A method allowing a user to monitor activities occurring within a vehicle as recited in claim 13, wherein upon receipt of said notice said user is given the ability to receive a live video feed from said receiver in said car.

18. A method allowing a user to monitor activities occurring within a vehicle as recited in claim 12, wherein upon receipt of said notice said user is given the ability to transmit voice data from said defined notice receiving device to said car.

19. A method allowing a user to monitor activities occurring within a vehicle as recited in claim 13, wherein upon receipt of said notice said user is given the ability to transmit voice data from said defined notice receiving device to said car.

20. A method allowing a user to monitor activities occurring within a vehicle as recited in claim 12, wherein upon receipt of said notice said user is given the ability to receive a live audio feed from said receiver in said car.
